(19) United States
(12) Patent Application Publication
(10) Pub. No.: US 2013/0100700 A1
(43) Pub. Date: Apr. 25, 2013

(54) LIGHT-EMITTING DEVICE AND CULTIVATION METHOD

(71) Applicant: Tomoki Kubo, Osaka-shi (JP)

(72) Inventor: Tomoki Kubo, Osaka-shi (JP)

(73) Assignee: SHARP KABUSHIKI KAISHA, Osaka-shi, Osaka (JP)

(21) Appl. No.: 13/805,275

(22) PCT Filed: Apr. 13, 2011
(86) PCT No.: PCT/JP2011/059200

§ 371 Date: Dec. 18, 2012

(30) Foreign Application Priority Data
Jun. 30, 2010 (JP) 2010-150285

(51) Int. Cl. F21V 8/00

(52) U.S. Cl. CPC G02B 6/0001
USPC 362/611

(57) ABSTRACT

The present invention is a light-emitting device (100) housing an illumination-target object (20), the light-emitting device (100) including: a pair of opening planes; an object placement member (1) on which the illumination-target object (20) is placed; a light guide member (2) for causing light introduced from an end of the light guide member (2) to exit from a light-exit surface (12) while guiding the light inside the light guide member (2); and a light source (3) provided at the end of the light guide member (2) and emitting light toward inside the light guide member (2), the light-exit surface (12) being formed into a hollow shape so that the illumination-target object (20) is housed inside the light-emitting device (100). This makes it is possible to easily and efficiently control an environment where the illumination-target object is placed.

### TECHNICAL FIELD

The present invention relates to a light-emitting device and a method for cultivating a plant by use of the light-emitting device.

### BACKGROUND ART

Conventionally, there has been a known technology for artificially cultivating plants by irradiating the plants with light from a lighting device.

For example, Patent Literature 1 describes a plant seedling-storage rack for storing a seedling. In the plant seedling-storage rack, the seedling is stored while irradiated with an appropriate intensity of light under a condition at a low temperature. This plant seedling-storage rack includes a plurality of shelf boards. On each of the plurality of shelf boards, a seedling box is provided. Further, the plant seedling-storage rack is provided with a lighting device between vertically adjacent shelf boards so that the lighting device provides light onto the seedling box from above the seedling box.

Until now, a fluorescent tube has been mainly used as a lighting device for artificial plant cultivation in view of cost and performance. However, in the future, an LED is expected to be mainly used as the lighting device in place of the fluorescent tube as a result of improvement in cost and performance of LEDs (light emitting diodes).

For example, Patent Literature 2 describes a light-emitting device employing an LED. This light-emitting device has a housing space which is formed by a transparent light guide so that a lower side is closed and an upper side is opened. The light-emitting device houses an illumination-target object in the housing space. Because the light guide is provided with a light-emitting body such as an LED, the illumination-target object housed in the housing space is irradiated with light from the light guide.

### CITATION LIST

### Patent Literatures

Patent Literature 1
Japanese Patent Application Publication, Tokukai, No. 2001-28946 (Publication Date: Feb. 6, 2001)

Patent Literature 2
Japanese Patent Application Publication, Tokukai, No. 2009-135050 (Publication Date: Jun. 18, 2009)

### SUMMARY OF INVENTION

### Technical Problem

In the field of agriculture, increase in needs for a plant factory is expected in the future. The plant factory refers to a method for (i) providing a multi-stage cultivating shelf for placing a plurality of plants in a space inside a container or the like and (ii) managing the plurality of plants all together. However, there are the following problems in applying a current cultivation method to such a plant factory.

Typically, when light is to be provided to a plant by use of a light source such as a fluorescent tube or an LED, a light source 201 is provided above an illumination-target object 203 as illustrated in FIG. 11 so that light is given to a surface of a leaf. FIG. 11 is a perspective view illustrating a configuration of a conventional cultivation shelf 200. In the cultivation shelf 200 of FIG. 11, a plurality of LEDs are provided as the light source 201 on a substrate, and illuminate a plant.

However, because light emitted from an LED travels linearly in one direction, the number of LEDs has to be increased for illuminating a whole plant. This may cause an increase in temperature of the substrate on which the LEDs are provided, and consequently damage the reliability of an illumination device. In order to solve this problem, cooling equipment 202 for cooling the substrate needs to be provided.

It is also required to air-condition an inside of the container for artificial plant cultivation. This disadvantageously requires an enormous amount of electric power for controlling such a large space inside the container. In addition, it is difficult to additionally control an airflow of the air to which a plant is exposed, even if air conditioning inside the container can be controlled.

In addition to the above-described problems, for example, a plant seedling-storage rack described in Patent Literature 1 has a problem in that a large number of light sources are necessary for securely obtaining a sufficient intensity of light. This is for the following reason. That is, in the plant seedling-storage rack, a light source is provided to a bottom surface of a shelf board and emits light downwards. In this configuration, a plant seedling can receive light from only one direction. Further, depending on a distance between shelf boards, a distance between the light source and the plant seedling becomes long. This causes the problem in that the large number of light sources is necessary as described above.

In a light-emitting device of Patent Literature 2, a light guide has a bowl-like shape for housing an illumination-target object. In a case where this light-emitting device is applied to a plant factory, a plurality of the light-emitting devices need to be provided inside the container. However it is not easy to control air conditioning inside respective housing spaces of the light-emitting devices all together.

The present invention is accomplished in view of the problems above, and an object of the invention is to provide a light-emitting device which is capable of controlling easily and efficiently an environment where an illumination-target object is placed.

### Solution to Problem

In order to solve the problems above, a light-emitting device of the present invention housing an illumination-target object, the light-emitting device includes: a pair of opening planes; an object placement member on which the illumination-target object is placed; a light guide member for causing light introduced from an end of the light guide member to exit from a light-exit surface while guiding the light inside the light guide member; and a light source provided at the end of the light guide member and emitting light toward inside the light guide member, the light-exit surface being formed into a hollow shape so that the illumination-target object is housed inside the light-emitting device.

According to the above configuration, in the light-emitting device of the present invention, the light source is provided at the end of the light guide member. The light guide member causes light introduced from an end of the light guide member to exit from the light-exit surface while guiding the light inside the light guide member. In addition, the light-exit surface is formed in a hollow shape so that the illumination-target object is housed inside the light-emitting device. Thus, the illumination-target object is irradiated with the light from many directions which light has exited from the light-exit surface.

For example, in a case where the illumination-target object is a plant, a light source is typically provided above a leaf and the leaf is irradiated with light from one direction so as to cause photosynthesize. However, with the light from one direction, light cannot be efficiently given to a whole plant due to overlap of leaves or the like. Because the light-emitting device has the above structure of the light-exit surface, light can be given efficiently from many directions.

Furthermore, in the present invention, the light emitted from the light sources is thrown onto the illumination-target object not directly but through the light guide member. Hence, it is possible to illuminate a wider area with a small number of light sources.

Moreover, because the illumination-target object is housed in a space formed by the light guide member, a distance between the light-exit surface and the illumination-target object is relatively short. Therefore, it is possible to illuminate sufficiently the illumination-target object with a small amount of light. This makes it possible to reduce the number of light sources. As a result, it becomes not necessary to provide a cooling system for cooling the light source.

Meanwhile, the light-emitting device of the present invention includes a pair of opening planes. For example, if the illumination-target object is dependent on a surrounding environmental condition such as a temperature or a humidity, air conditioning in the space housing the illumination-target object needs to be controlled. In the present invention, because the illumination-target object is not in a closed space but in an open space having the pair of opening planes, it is easy to control air conditioning inside the light-emitting device.

### Advantageous Effects of Invention

The present invention is a light-emitting device housing an illumination-target object, the light-emitting device including: a pair of opening planes; an object placement member on which the illumination-target object is placed; a light guide member for causing light introduced from an end of the light guide member to exit from a light-exit surface while guiding the light inside the light guide member; and a light source provided at the end of the light guide member and emitting light toward inside the light guide member, the light-exit surface being formed into a hollow shape so that the illumination-target object is housed inside the light-emitting device. Therefore, it is possible to easily and efficiently control an environment where the illumination-target object is provided.

### DESCRIPTION OF EMBODIMENTS

### Brief Description of Drawings

FIG. 1 is a cross-sectional view illustrating a configuration of a light-emitting device of an embodiment according to the present invention.

FIG. 2 is a perspective view illustrating the configuration of the light-emitting device illustrated in FIG. 1.

FIG. 3 is a side view illustrating the configuration of the light-emitting device as illustrated in FIG. 1.

FIG. 4 is a view illustrating a flow of the air in the light-emitting device illustrated in FIG. 1.

FIG. 5 is a view illustrating an example of cultivating a plant by use of the light-emitting device illustrated in FIG. 1.

FIG. 6 is a view illustrating an example of a method for connecting light-emitting devices as illustrated in FIG. 1.

FIG. 7 is a cross-sectional view illustrating a configuration of a light-emitting device in accordance with another embodiment of the present invention.

FIG. 8 is a view illustrating an example of cultivating a plant by use of the light-emitting device illustrated in FIG. 7.

FIG. 9 is a view illustrating an example of a method for connecting light-emitting devices as illustrated in FIG. 7.

FIG. 10 is a cross-sectional view illustrating a configuration of the light-emitting device in accordance with another embodiment of the present invention.

FIG. 11 is a perspective view illustrating a configuration of a conventional cultivating shelf.

### DESCRIPTION OF EMBODIMENTS

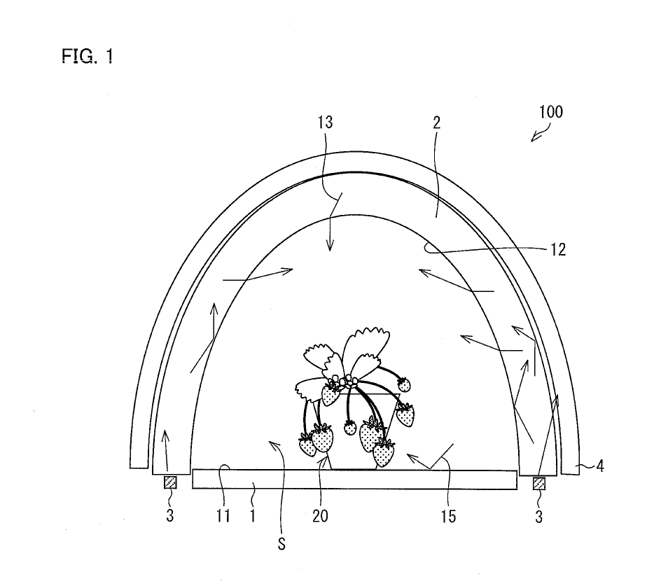

The following discusses an embodiment of a light-emitting device of the present invention, with reference to FIGS. 1 to 10.

### First Embodiment

First, the present embodiment discusses a configuration of a light-emitting device 100, with reference to FIGS. 1 to 5.

(Configuration of Light-Emitting Device 100)

FIG. 1 is a cross-sectional view illustrating the configuration of the light-emitting device 100 of the embodiment of the present invention.

The light-emitting device 100 of the present embodiment is an optical member which houses an illumination-target object 20 and which illuminates the illumination-target object 20. The light-emitting device 100 includes an object placement section 1 (an object placement member), a light guide 2 (a light guide member), light sources 3, and a reflecting layer 4 (a reflecting member).

Specifically, the light sources 3 are provided at respective ends of the light guide 2 in the shape of a hog-backed shape. The light guide 2 is provided above the object placement section 1 where the illumination-target object 20 is to be placed. In other words, the illumination-target object 20 is housed in a space S being surrounded by the object placement section 1 and the light guide 2.

Moreover, because an outside surface (i.e., a surface that is not in contact with the space S) of the light guide 2 has been subjected to a treatment (not illustrated) for regulating light emitted through the light guide 2, an inner surface of the light guide 2 serves as a light-exit surface 12 for allowing light to exit.

In the present embodiment, because the light guide 2 has the hog-backed shape, the light-exit surface 12 is also formed into a hog-backed shape. However, the shape of the light guide 2 is not limited to this. The light guide 2 only needs to have a hollow structure so as to enclose the illumination-target object 20 on an inner side of the light-exit surface 12. For example, the light-exit surface 12 may have an inner surface in the form of an inverted V-shape or a quadrangular shape.

Note that the shapes of the light guide 2 and the light-exit surface 12 do not necessarily need to be the same. Such shapes allow the light exiting from the light-exit surface 12 to be thrown onto the illumination-target object from many directions.

For example, in a case where the illumination-target object 20 is a plant, a light source is typically provided above a leaf and the leaf is irradiated with light from one direction so as to cause photosynthesize. However, with the light from one direction, light cannot be efficiently given to a whole plant due to overlap of leaves or the like. Because the light-emitting device 100 has the above structure of the light-exit surface 12, light can be given efficiently from many directions.

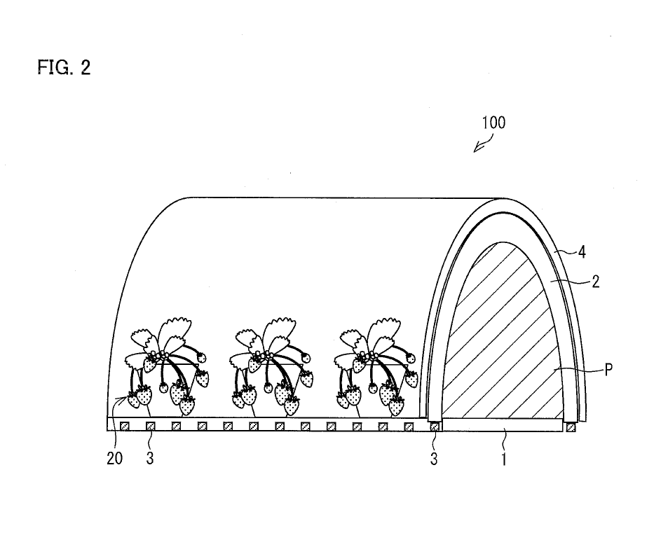

Further, the light emitting device 100 has a pair of opening planes (openings, apertures). In the present embodiment, because the light guide 2 has a tunnel shape as illustrated in FIG. 2, an entrance and an exit of a tunnel serve as a pair of opening planes P. FIG. 2 is a perspective view illustrating a configuration of the light-emitting device 100 of FIG. 1.

For example, if the illumination-target object 20 is dependent on a surrounding environmental condition such as a temperature or a humidity, air conditioning in the space S housing the illumination-target object 20 needs to be controlled. In the light-emitting device 100, because the illumination-target object 20 is not in a closed space but in an open space having the pair of opening planes P, it is easy to control air conditioning inside the light-emitting device 100.

Thus, in the present embodiment, the pair of opening planes P is formed by sides which are surrounded by a part of an periphery of the light guide 2 and a part of the object placement section 1 in contact with the periphery of the light guide 2. Alternatively, either of the object placement section 1 or the light guide 2 may have the pair of opening planes.

In the object placement section 1, the illumination-target object 20 is placed. The object placement section 1 forms a bottom surface of the space S in the present embodiment. A configuration of the object placement section 1 is not specifically limited. However, preferably, an object placement surface 11 where the illumination-target object 20 is placed reflects light.

For example, even in a case where light exiting from the light-exit surface 12 travels downwards without irradiating the illumination-target object 20, it is possible to cause the light to return back onto a side where the illumination-target object 20 is provided in a configuration in which light is reflected by the object placement surface 11 on which the illumination-target object 20 is placed.

Therefore, it is possible to use light efficiently, and illuminate the illumination-target object 20 by light from all directions.

In this case, the object placement section 1 may be made of a reflective material that reflects light, or a suitable substrate on which a layer of a reflective material is provided. The reflective material is not specially limited as long as the reflective material is made of a material which reflects light. Examples of a form of the reflective material are a sheet, a plate, or a film.

The light guide 2 causes light to exit from the light-exit surface 12 while guiding introduced light inside the light guide 2. In the present embodiment, since the light sources 3 are provided at the respective ends of the light guide 2 as illustrated in FIG. 1, light is introduced mainly from the respective ends of the light guide 2.

The light guide 2 may be any light guide that guides light, but it is particularly preferable that the light guide 2 is made of a transparent material. Examples of such a transparent material encompass transparent materials of methacrylate resin such as PMMA (methyl methacrylate resin), COP (cycloolefin polymer) such as “ZEONOR” (registered trademark, manufactured by ZEON CORPORATION), COC (cycloolefin copolymaer), and polycarbonate.

The light guide 2 should have a shape that allows the light-exit surface 12 to have a hollow structure. For example, in a case where the light guide 2 forms the pair of opening planes P, the light guide 2 can be formed into a tunnel shape as described above.

Furthermore, when the light-exit surface 12 is formed by the light guide 2, the number of the light guide 2 to be used is not specially limited. For example, it is possible to use one light guide 2 having a hog-backed shape, or two plate-like light guides 2 that are combined so as to form an inverted V-shape or a quadrangular shape. In the present specification, regardless of the number of light guides 2 that are used, the light-exit surfaces 12 of the light guides 2 are considered to be one continuous light-exit surface 12 as long as these light-exit surfaces 12 are connected.

Moreover, the light guide plate 2 can be configured to be detachable. For example, in a case where a plurality of illumination-target objects 20 are housed by use of a plurality of light-emitting devices 100, opening planes of the plurality of light emitting devices 100 may be connected so that air conditioning in the light-emitting devices 100 may be controlled all together.

In this case, when the illumination-target object 20 housed in each of the light-emitting devices 100 is individually taken out, it is possible in the configuration in which the light guide 2 is detachable to take out the illumination-target object 20 without disconnecting each light-emitting device 100 from other light-emitting devices 100. This makes it possible to keep leakage of conditioned air to a minimum in the plurality of light-emitting devices 100 as a whole.

The light sources 3 are provided at the respective ends of the light guide 2 and emit light to an inside of the light guide 2. That is, the light emitted from the light sources 3 does not directly illuminate the illumination-target object 20 but illuminates through the light guide 2. Therefore, it is possible to illuminate a wider area with a smaller number of light sources 3.

Further, because the illumination-target object 20 is housed in the space S formed by the light guide 2, a distance between the light-exit surface 12 and the illumination-target object 20 is relatively short. Therefore, it is possible to reduce the number of light sources 3 because sufficient light can be given to the illumination-target object 20 with a small amount of light. As a result of the reduction in the number of light sources 3 as described above, for example, it is possible to suppress a temperature rise of a surrounding member caused by heat generated by the light sources 3. This consequently makes it unnecessary to provide a cooling mechanism.

Possible examples that can be used as the light sources 3 are LEDs (light emitting diodes) or cold cathode fluorescent lamps (CCFLs). In a case where the light guide 2 has a tunnel shape, a light source 3 may be provided along a longitudinal direction of a tunnel. Here, for example, if the light source 3 is an LED, a plurality of light sources 3 can be provided in accordance with a length of the tunnel.

The reflecting layer 4 reflects light, provided so as to cover a surface of the light guide 2 which surface is on an opposite side to the light exit-surface 12 of the light guide 2.

This makes it possible to irradiate efficiently the illumination-target object 20 with light guided by the light guide 2. In other words, the light introduced into the light guide 2 may leak out from the surface on the opposite side to the light-exit surface 12, while the light is being guided inside the light guide 2.

In order to solve the above problem, the reflecting layer 4 for reflecting light is provided on the surface on the opposite side to the light-exit surface 12. This makes it possible to prevent light leakage to the outside and consequently to emit more light from the light-exit surface 12.

The reflecting layer 4 is not specially limited as long as the reflecting layer 4 is made of a reflective material. The reflective material may be in the form of, for example, a sheet, a plate, or a film.

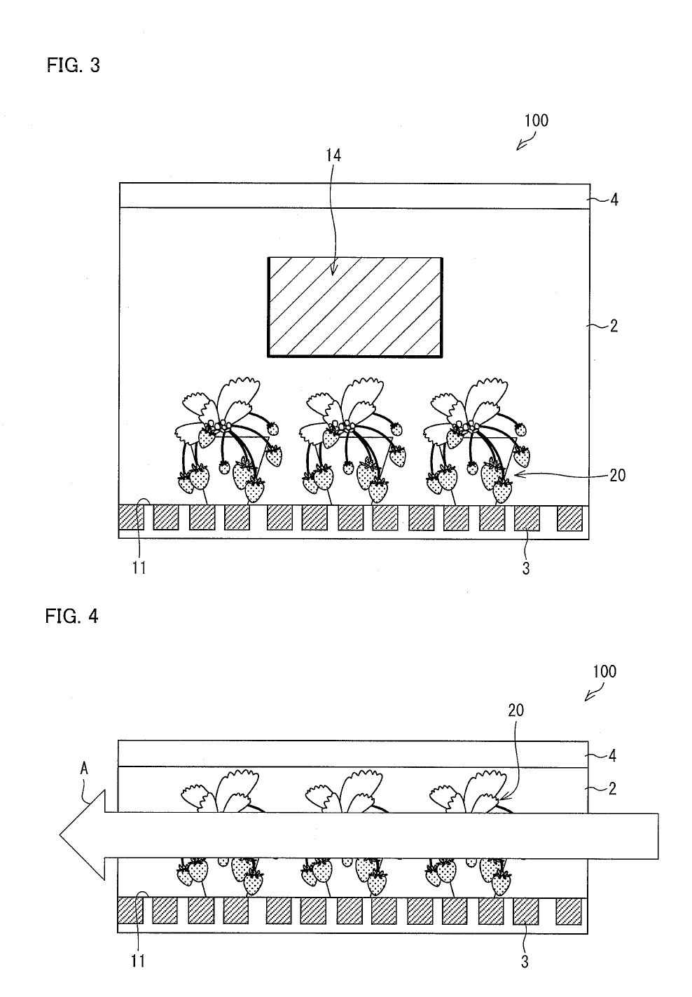

Further, there is no limitation to an area covered by the reflecting layer 4 on an outer surface of the light guide 2. However, it is preferable to have, for example, an opening 14 like a cut section where a part of the reflecting layer 4 is cut as illustrated in FIG. 3. FIG. 3 is a side view illustrating the configuration of the light-emitting device 100 illustrated in FIG. 1.

For example, in a case where the reflecting layer 4 covers entirely the outer surface of the light guide 2, it is necessary to detach the light guide 2 for looking into the space S. By providing the opening 14 to a part of the reflecting layer 4, it becomes possible to look into the space S without removal of the light guide 2. Note that a location and the number of the opening 14 are not specifically limited.

(Configuration of Light Guide 2)

In the light-emitting device 100, the light-exit surface 12 is formed so that the illumination-target object 20 placed on the object placement section 1 is housed inside the light-emitting device 100. This makes it possible to illuminate the illumination-target object 20 from various directions.

In other words, the light sources 3 are provided at the respective ends of the light guide 2. Then, light emitted from the light sources 3 is introduced into the light guide 2 from the respective ends and guided inside the light guide 2. When the light (whose light path is shown by arrows 13 in FIG. 1) to be guided enters an interface (i.e., the light-exit surface 12) between the light guide 2 and the space S at an angle that fails to satisfy a condition for total reflection, the light that is not reflected at the interface exits to the space S.

Because the outer surface of the light guide 2 is treated (not illustrated) as described above for regulating light to be emitted from the light guide 2, it is possible to regulate the light so that (i) the light being guided inside the light guide 2 changes an angle of incidence when entering the light-exit surface 12 and (ii) the light is caused to exit outside from the light guide 2.

One example of a treatment carried out on the light guide 2 is forming a pattern of a discretionarily selected shape. An example of a method for forming the pattern is silk print, surface texturing or the like.

Because the light guide 2 has a tunnel shape as described above, the opening planes P which serve as an entrance and an exit of the light guide 2 face each other. In this manner, the pair of opening planes P is provided to the light-emitting device 100, and the space S for housing the illumination-target object 20 is surrounded by the light guide 2. This produces a flow of the air as shown by an arrow A in FIG. 4. FIG. 4 shows the flow of the air in the light-emitting device 100 of FIG. 1.

For example, in a case where a plant is artificially cultivated indoors, it is necessary to control a condition of an environment surrounding the plant, for example, a concentration of carbon dioxide, a humidity, or a temperature, as well as illuminating the plant. In such a case, conventionally, an environment is controlled by regulating air conditioning of an entire indoor space. This results in consumption of a large amount of electric energy. Further, in a case where a large space is used for cultivating a plant, it is difficult to additionally control an airflow of the air to which the plant is exposed.

Meanwhile, in the present invention, only a flow of the air inside the light-emitting device 100 only needs to be controlled. Accordingly, air conditioning only needs to be controlled for a bare minimum space. This makes it possible to easily control the airflow of the air to which the plant is exposed. Because a volume of a target space for control accordingly becomes smaller, it is possible to reduce power consumption for control on air conditioning and to easily condition an environment surrounding the plant.

Further, in the light-emitting device 100, the opening planes P make a pair. Accordingly, the air taken in through one of the opening planes P exits from the other one of the opening planes P. In other words, a flow of the air can be produced. For example, in a case where the illumination-target object 20 is a plant, a photosynthetic rate is increased by exposure of the plant to the wind. Therefore, it is possible to facilitate photosynthesis by exposing the plant to a constant flow of the external air for conditioning.

(Plant Cultivation Method)

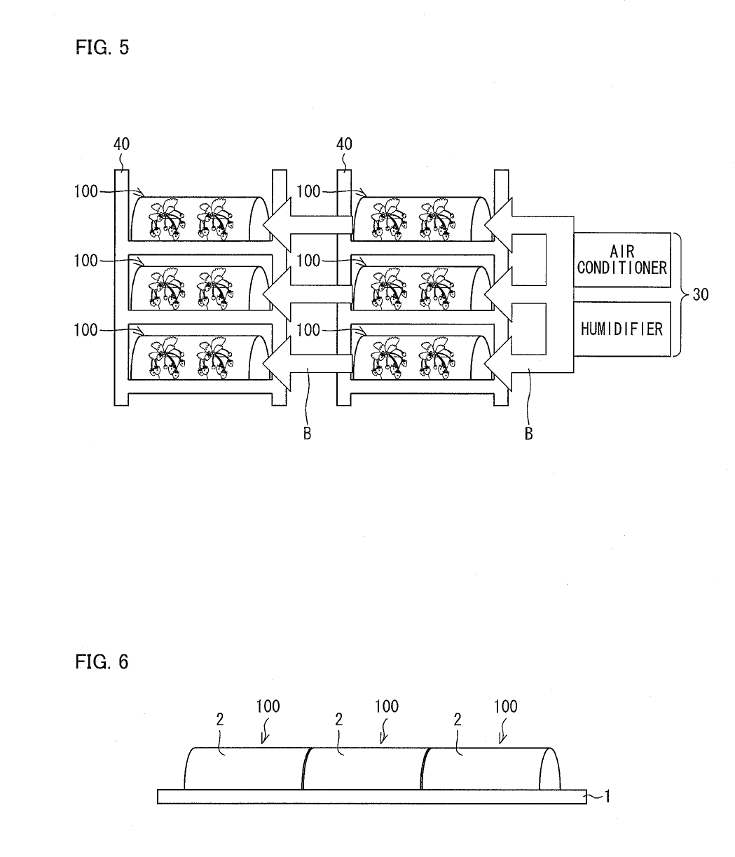

The present invention encompasses a method for cultivating a plant housed in a light-emitting device of the present invention. FIG. 5 shows an example of cultivating plants in light-emitting devices 100 as illustrated in FIG. 1.

In the present embodiment, a plurality of multi-stage cultivation shelves 40 that are in the same form are provided indoors. Further, each of multiple stages of each of the plurality of multi-stage cultivation shelves 40 is provided with the light-emitting device 100 and a plant is cultivated inside each light-emitting device 100.

For example, a reflection sheet is provided as the object placement section 1 on each of the multiple stages of the plurality of multi-stage cultivation shelves 40 and the light guide 2 is provided so as to cover the plant. Further, the light guide 2 is covered with another reflection sheet which serves as the reflecting layer 4 so that light does not leak to the outside. At respective ends of the light guide 2, the light sources 3 such as LEDs or CCFLs are provided so that light is introduced into the light guide 2 from the respective ends.

As described above, the light guide 2 has the light-exit surface 12 that forms the hollow structure and this light guide 2 is arranged to cover a plant. Accordingly, the plant can be irradiated with light from many directions. Further, the reflection sheet is provided on a surface where the plant is placed. Accordingly, the plant can be exposed to light that has not struck the plant, by reflecting the light back by the reflection sheet.

Moreover, opening planes P of respective light-emitting devices 100 on adjacent cultivation shelves 40 are connected to each other by a connecting member (not illustrated) such as an air hose. Further, a light-emitting device 100 provided on an endmost cultivation shelf 40 is connected to an air conditioner 30.

Examples of the air conditioner 30 are an air conditioner, a humidifier, or a carbon dioxide supplying unit. The connecting member is not limited to an air hose but may be anything that is capable of sending, to another light-emitting device 100, the air supplied from the air conditioner 30 to one light-emitting device 100.

As for connection between the air conditioner 30 and the light-emitting device 100, it is only necessary to establish a series of flows of the air as shown by arrows B of FIG. 5. For example, an outlet of the air conditioner can be connected by an air hose to the opening plane P of the light-emitting device 100.

In this manner, it is possible to easily produce a flow of the air from a foremost light-emitting device 100, to which the air conditioner 30 is connected, to a subsequently connected light-emitting device 100 by aligning and connecting a plurality of light-emitting devices 100 with use of connecting members.

In addition, power consumption can be suppressed because the air only needs to be sent at an airflow that allows the air from the air conditioner 30 to reach all over the space S inside the light-emitting device 100. Furthermore, the air is reliably sent to the space S. This makes it easy to condition an environment surrounding a plant and accordingly makes it possible to facilitate photosynthesis by supplying a sufficient amount of air to the plant placed in the space S.

In FIG. 5, since a distance between adjacent light-emitting devices 100 is relatively long, these light-emitting devices 101 are connected to each other by using the connecting member. However, such light-emitting devices 100 can be connected directly to each other. FIG. 6 shows an example of a method for connecting the light-emitting devices 100.

In a case as illustrated in FIG. 6 where the light-emitting devices 100 each have a tunnel shape, it is possible to produce a flow of the air from one light-emitting device 100 to another light-emitting device 100 by connecting the opening planes P so that the opening planes P face each other. This makes it possible to increase the number of the light-emitting devices 100 that are provided in an indoor space and also to secure a large space for harvests.

However, the connection between the light-emitting devices 100 is not limited to the above-described methods. The light-emitting devices 100 can be connected appropriately, depending on locations of the opening planes P or the like.

Note that in an endmost light-emitting device 100 which is located at an end on an opposite side to a side where the air conditioner 30 is connected, the opening plane P that is a dead end for the flow of the air may be sealed by the reflection sheet or the like, or alternatively may be designed to connect to the air conditioner 30 so that the air returns back to the air conditioner 30.

As described earlier, if an opening is provided to the reflection sheet 4 of the light-emitting device 100, it is possible to observe plant growth in the space S. Furthermore, for example, if the light guide 2 is detachable, it is possible to harvest a fully grown plant housed in the light-emitting device 100 by removing the light guide 2. Thus, it is possible to keep leakage of the air to a minimum.

### Second Embodiment

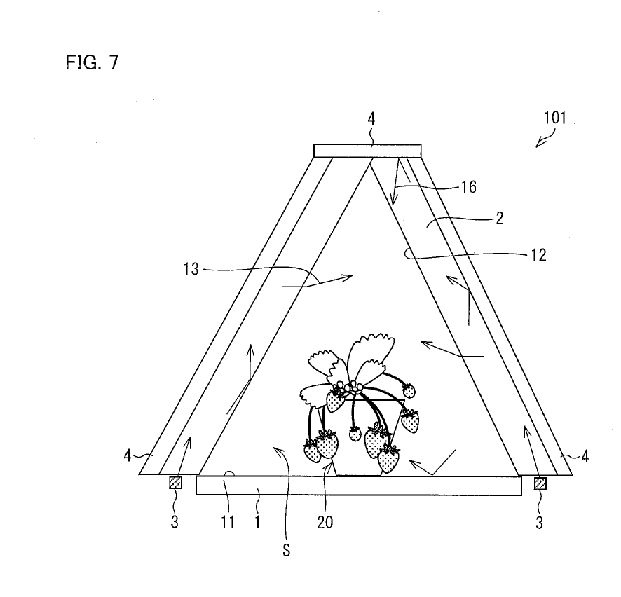

The following discusses Second Embodiment of a light-emitting device in accordance of the present invention, with reference to FIG. 7.

FIG. 7 is a cross-sectional view illustrating a configuration of a light-emitting device 101 of an embodiment in accordance with the present invention. Note that members having functions identical to those of the respective members described in First Embodiment are given respectively identical numerals.

In the light-emitting device 101 of the present invention, a light guide 2 has a different shape from that of First Embodiment. Specifically, two plate-like light guides 2 are combined so that a light-exit surface 12 has an inverted-V tunnel shape.

As in First Embodiment, only air conditioning inside a space S of a tunnel shape needs to be controlled in the present embodiment. Accordingly, power consumption can be reduced to a large degree. In addition, the plate-like light guides 2 can be more easily produced than a hog-backed shape light guide 2. This makes it possible to reduce cost.

Outer surfaces of the light guides 2 only needs to have a pattern of a discretionarily selected shape by, for example, silk print, surface texturing or the like. In a case where the plate-like light guides 2 are used, a form of the plate-like light guides 2 as a whole may take any shape as long as light can enter the plate-like light guides 2. The plate-like light guides 2 may take, for example, a parallelogram shape.

An end of each of the light guides 2, namely, a lower end of each of the light guides 2 of FIG. 7 is provided with a light source 3 and light is introduced from a lower side of each of the light guides 2. In this manner, the light sources 3 can emit light onto an illumination-target object 20 through the light guides 2. This makes it possible to irradiate the illumination-target object 20 placed in the space S, with light from various directions.

A volume of the space S should be set in accordance with a size of the illumination-target object 20. Accordingly, it is possible to illuminate efficiently the illumination-target object 20. At the same time, because a distance between the light source 3 and the plant is short, the number of the light sources 3 can be reduced. As a result, it becomes not necessary to provide a cooling mechanism for cooling the light sources 3.

Note that (i) when the light sources 3 are LEDs, a plurality of LEDs should be arranged along a longitudinal side of a tunnel and (ii) when the light sources 3 are CCFLs, the CCFLs should be arranged in parallel to a longitudinal side of a tunnel.

Further, as in First Embodiment, in the light-emitting device 101, a surface on an opposite side to the light-exit surface 12 of each of the light guides 2 is covered with the reflecting layer 4 so that light is prevented from leaking to the outside. In the present embodiment, the reflecting layer 4 is further provided at ends of the light guides 2 which ends are on a side (an upper side) where no light source 3 is provided.

In other words, in the light-emitting device 101, the light guides 2 are combined so that the light guides 2 come in contact at a vertex section of the inverted-V shape. As shown in FIG. 7, a cross section of the light guides 2 is structured by two symmetrical parallelograms that are connected with each other. Here, the vertex section is exposed even when the reflecting layer 4 simply covers a surface on the opposite side to the light-exit surface 12 of the light guide 2.

According to the light-emitting device 101, because two light guides 2 are connected to each other, light introduced through one end of each of the light guides 2 is guided to the other end of each of the light guides 2. Here, the other end of each of the light guides 2 forms the vertex section of the inverted V-shape. Therefore, if the other end is exposed, light may leak out from the other end.

In order to solve the above problem, as shown with arrows 16 of FIG. 7, the reflecting layer 4 provided at the other end section on an upper side of the each light guide 2 can reflect light that reaches the other end and causes the light to return back to the light guide 2. Thus, it is possible to prevent light from leaking out to the outside and thereby to improve efficiency in utilization of light.

Even when the light-exit surface 12 has an inverted V-shape as described above, the illumination-target object 20 can be irradiated with light from many directions. Because the light guide 2 has a tunnel shape, a flow of the air can be produced inside the space S.

FIG. 8 illustrates an example of plant cultivation by use of the light-emitting device 101 of the above configuration. FIG. 8 is a view illustrating an example of plant cultivation in the light-emitting device 101 of FIG. 7.

As in First Embodiment, in the present embodiment, a plurality of multi-stage cultivation shelves 40 that are in the same form are provided indoors. Further, each of multiple stages of each of the plurality of multi-stage cultivation shelves 40 is provided with the light-emitting device 101 and a plant is cultivated inside each light-emitting device 101.

For example, a reflection sheet is provided on each of the multiple stages of the plurality of multi-stage cultivation shelves 40 and the light guides 2 are provided so as to cover the plant. Further, the light guides 2 are covered with another reflection sheet which serves as the reflecting layer 4 so that light does not leak to the outside. At an end of each of the light guide 2, the light source 3 such as an LED or a CCFL is provided so that light is introduced into each of the light guides 2 from the end.

As in First Embodiment, in the present embodiment, the light guides 2 as a whole have the light-exit surface 12 that forms the hollow structure and the light guides 2 are arranged to cover a plant. Accordingly, the plant can be irradiated with light from many directions. Further, the reflection sheet is provided on a surface where the plant is placed. Accordingly, the plant can be exposed to light that has not struck the plant, by reflecting the light back by the reflection sheet.

Moreover, opening planes P of respective light-emitting devices 101 on adjacent cultivation shelves 40 are connected to each other by a connecting member (not illustrated) such as an air hose. Further, a light-emitting device 101 provided on an endmost cultivation shelf 40 is connected to an air conditioner 30. In the present embodiment, connection of light-emitting devices 101 and connection of a light-emitting device 101 and an air conditioner 30 can be made as in First Embodiment.

In this manner, it is possible to easily produce a flow of the air as shown by arrows B of FIG. 8 from a foremost light-emitting device 101 to a subsequently connected light-emitting device 101 by aligning and connecting a plurality of light-emitting devices 101 with use of connecting members.

In addition, power consumption can be suppressed because the air only needs to be sent at an airflow that allows the air from the air conditioner 30 to reach all over the space S inside the light-emitting device 101. Furthermore, the air is reliably sent to the space S. This makes it easy to condition an environment surrounding a plant and accordingly makes it possible to facilitate photosynthesis by supplying a sufficient amount of air to the plant placed in the space S.

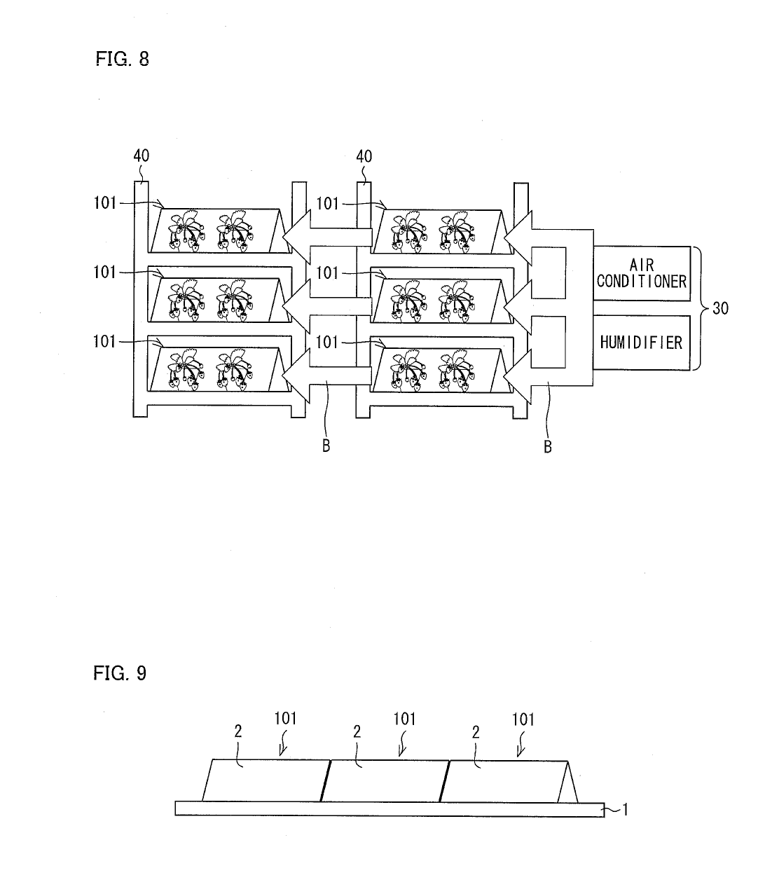

In FIG. 8, since a distance between adjacent light-emitting devices 101 is relatively long, these light-emitting devices 101 are connected to each other by using the connecting member. However, such light-emitting devices 101 can be connected directly to each other. FIG. 9 shows an example of a method for connecting the light-emitting devices 101.

In a case as illustrated in FIG. 9 where the light-emitting devices 101 each have a tunnel shape, it is possible to produce a flow of the air from one light-emitting device 101 to another light-emitting device 101 by connecting the opening planes P so that the opening planes P face each other. This makes it possible to increase the number of the light-emitting devices 101 that are provided in an indoor space and also to secure a large space for harvests.

However, the connection between the light-emitting devices 101 is not limited to the above-described methods. The light-emitting devices 101 can be connected appropriately, depending on locations of the opening planes P or the like.

### Third Embodiment

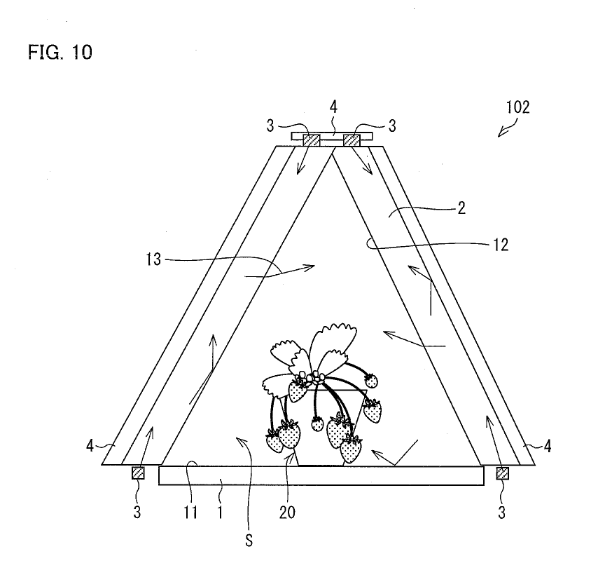

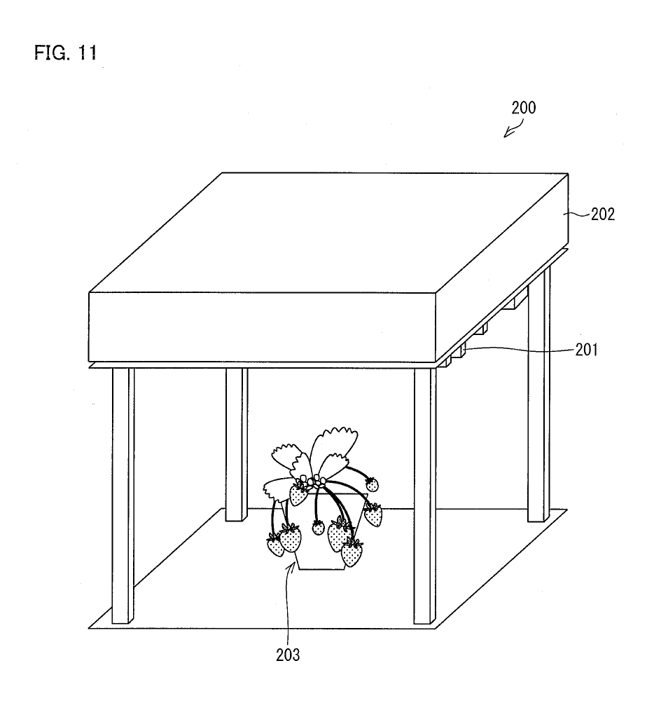

The following discusses Third Embodiment of a light-emitting device in accordance with the present invention, with reference to FIG. 10.

FIG. 10 is a cross-sectional view illustrating a configuration of a light-emitting device 102 of an embodiment in accordance with the present invention. Note that members having functions identical to those of the respective members described in First Embodiment are given respectively identical numerals.

In the light-emitting device 102 of the present invention, locations of light sources 3 are different from those of Second Embodiment.

Specifically, two plate-like light guides 2 are combined so that a light-exit surface 12 has an inverted V-shaped tunnel shape. Further, the light guides 2 are respectively provided with additional light sources 3 at the other ends which form a vertex section of an inverted V-shape. As a result, light is introduced into each of the light guides 2 from both ends of each of the light guides 2.

In other words, in the light-emitting device 102, the light guides 2 are combined so that the light guides 2 come in contact at the vertex section of the inverted-V shape, and the light sources 3 are provided at the vertex section. Since light is introduced through the both ends of each of the light guides 2, it is possible to increase an intensity of light given to the illumination-target object 20, as compared to First Embodiment and Second Embodiment.

As in Second Embodiment, in the present embodiment, a cross section of the light guides 2 is structured by two symmetrical parallelograms that are connected with each other. Accordingly, as it is, light may leak out from the vertex section to the outside. However, in the light-emitting device 102, a reflecting layer 4 is additionally provided above the light sources 3 that are provided at the vertex section. This makes it possible to reflect light that has reached the vertex section so that the light goes back into the light guides 2. Therefore, it is possible to prevent light from leaking to the outside and to improve efficiency in utilization of light.

Even when the light-exit surface 12 has an inverted V-shape as described above, the illumination-target object 20 can be irradiated with light from many directions. Further, even if light introduced from a lower side cannot provide a sufficient intensity of light, it is possible to introduce light from an upper side of each of the light guides 2. Therefore, the illumination-target object 20 can be irradiated with a sufficient intensity of light.

Note that the reflecting layer 4 does not have to be in a plate-like form. For example, a continuous reflecting layer 4 may be provided along an inverted V-shaped surface.

The light-emitting device 102 with the above-described configuration may be used for cultivating a plant. In this case, as in examples illustrated in FIG. 5 and FIG. 8, a plurality of multi-stage cultivation shelves 40 that are in the same form are provided indoors, and each of multiple stages of each of the plurality of multi-stage cultivation shelves 40 is provided with the light-emitting device 102. Then, a plant can be cultivated inside each light-emitting device 102.

Moreover, opening planes P of respective light-emitting devices 102 on adjacent cultivation shelves 40 can be connected to each other by a connecting member (not illustrated) such as an air hose. Further, a light-emitting device 102 provided on an endmost cultivation shelf 40 can be connected to an air conditioner 30.

In this manner, it is possible to easily produce a flow of the air from a foremost light-emitting device 102 to a subsequently connected light-emitting device 102 by aligning and connecting a plurality of light-emitting devices 102 with use of connecting members.

In addition, power consumption can be suppressed because the air only needs to be sent at an airflow that allows the air from the air conditioner 30 to reach all over the space S inside the light-emitting device 102. Furthermore, the air is reliably sent to the space S. This makes it easy to condition an environment surrounding a plant and accordingly makes it possible to facilitate photosynthesis by supplying a sufficient amount of air to the plant placed in the space S.

In the light-emitting device of the present invention, it is preferable to include a reflecting member for reflecting light, the reflecting member covering a surface on an opposite side to the light-exit surface of the light guide member.

According to the above configuration, it is possible to efficiently irradiate the illumination-target object with light that is being guided by the light guide member. In other word, light which is introduced into the light guide member may leak out from a surface on an opposite side to the light-exit surface of the light guide member, while being guided inside the light guide member.

In order to solve this problem, the surface on the opposite side to the light-exit surface is provided with a reflecting member that reflects light. This makes it possible to prevent light from leaking out to the outside and to cause more light to exit from the light-exit surface.

In the light-emitting device of the present invention, it is preferable that light is reflected by a surface of the object placement member, on which surface the illumination-target object is placed.

For example, even in a case where light having exited from the light-exit surface directly travels downwards without striking the illumination-target object, it is possible to return the light back to a side where the illumination-target object is placed in a configuration in which the illumination-target object is placed on a surface that reflects light.

In the light-emitting device of the present invention, it is preferable that the reflecting member includes an opening.

According to the above configuration, the reflecting member has an opening. Therefore, it is possible to observe the illumination-target object that is placed inside the light-emitting device, without removing the light guide member.

In order to solve the above problems, a cultivation method of the present invention includes the step of cultivating a plant housed in the light-emitting device of the present invention.

According to the above configuration, the cultivation method of the present invention is a method for cultivating a plant housed in the light-emitting device of the present invention. In other words, the plant is an illumination-target object in the light-emitting device. Therefore, it is possible to irradiate the plant efficiently with light from many directions and to easily control air conditioning of a space in which a plant is housed.

The present invention is not limited to the description of embodiments above but may be altered within the scope of the claims. An embodiment based on a proper alteration of the embodiments based on common general technical knowledge and an embodiment based on a combination of the embodiments are encompassed in the embodiments of the present invention.

### INDUSTRIAL APPLICABILITY

The present invention is applicable to a general illumination means, and can be suitably applied to illumination means employed in, for example, a plant factory for artificially cultivating plant cultivation, or the like.

### REFERENCE SIGNS LIST

1 Object placement section (Object placement member)
2 Light guide (Light guide member)
3 Light source
4 Reflecting layer (Reflecting member)
100, 101, 102 Light-emitting device

1. A light-emitting device housing an illumination-target object, said light-emitting device comprising:
a pair of opening planes;
an object placement member on which the illumination-target object is placed;
a light guide member for causing light introduced from an end of the light guide member to exit from a light-exit surface while guiding the light inside the light guide member; and
a light source provided at the end of the light guide member and emitting light toward inside the light guide member,
the light-exit surface being formed into a hollow shape so that the illumination-target object is housed inside the light-emitting device.

2. The light-emitting device as set forth in claim 1, further comprising a reflecting member for reflecting light, the reflecting member covering a surface on an opposite side to the light-exit surface of the light guide member.

3. The light-emitting device as set forth in claim 1, wherein light is reflected by a surface of the object placement member, on which surface the illumination-target object is placed.

4. The light-emitting device as set forth in claim 2, wherein the reflecting member includes an opening.

5. A method for cultivating a plant housed in the light-emitting device as set forth in claim 1.
